(19) United States
(12) Patent Application Publication
(10) Pub. No.: US 2026/0195427 A1
(43) Pub. Date: Jul. 9, 2026

(54) ORDERED TEMPORARY CREDENTIALS FOR ZERO-TRUST SYSTEMS

(71) Applicant: Amazon Technologies, Inc., Seattle, WA (US)

(72) Inventors: Nitish GOYAL, Bengaluru (IN); Murali Panayadka KRISHNA, Bangalore (IN)

(21) Appl. No.: 19/011,192

(22) Filed: Jan. 6, 2025

(51) Int. Cl. G06F 21/31

(52) U.S. Cl. CPC G06F 21/31

(57) ABSTRACT

Techniques for implementing and utilizing ordered temporary credentials for a zero-trust system implemented in a multi-tenant cloud provider network are described. An Access Management (AM) service obtains ordering configuration indicating a sequence or pattern of requests that are allowed to be made in association with a credential or session. In authorizing requests made to services, the AM service can determine if the request, together with any other requests made via the credential or session, matches the constraints defined by the ordering configuration, and deny an access when the request would violate the ordering configuration.

### BACKGROUND

Cloud provider networks offer numerous benefits, including scalability, flexibility, and cost-efficiency. By leveraging cloud resources, businesses can quickly scale their infrastructure to match demand, avoiding the need for significant upfront investments in hardware. Additionally, cloud providers offer a variety of services and tools that enhance productivity and innovation, enabling organizations to develop and deploy applications faster and more efficiently. With global reach, cloud networks also ensure high availability and low latency, providing users with seamless access to applications and services regardless of their location.

Security in cloud provider networks is paramount, and the use of credentials plays a crucial role in protecting resources and data. Cloud providers implement robust access management (AM) systems, allowing users to create and manage credentials with fine-grained access controls. These credentials, which can include Application Programming Interface (API) keys, access tokens, and user accounts, ensure that only authorized individuals and applications can access specific resources. By enforcing strong authentication methods and regularly rotating credentials, cloud providers help mitigate the risk of unauthorized access and data breaches, safeguarding the integrity and confidentiality of users' information.

### BRIEF DESCRIPTION OF DRAWINGS

Various examples in accordance with the present disclosure will be described with reference to the drawings, in which:

FIG. 1 is a diagram illustrating an environment for implementing and utilizing ordered temporary credentials for a zero-trust system implemented in a multi-tenant cloud provider network according to some examples.

FIG. 2 is a sequence-type diagram illustrating ordering configuration compliant ordered temporary credential utilization for a zero-trust system according to some examples.

FIG. 3 is an example diagram illustrating operations for ordering configuration validation for requests utilizing ordered temporary credentials according to some examples.

FIG. 4 is a sequence-type diagram illustrating ordering configuration non-compliant ordered temporary credential utilization for a zero-trust system according to some examples.

FIG. 5 is a diagram illustrating an exemplary ordering configuration and various compliant and non-compliant audit logs according to some examples.

FIG. 6 is a diagram illustrating multi-version ordering configuration support for supporting multiple concurrent service code variants according to some examples.

FIG. 7 is a flow diagram illustrating operations of a method for implementing and utilizing ordered temporary credentials for a zero-trust system implemented in a multi-tenant cloud provider network according to some examples.

FIG. 8 illustrates an example cloud provider network environment according to some examples.

FIG. 9 is a block diagram of an example cloud provider network that provides a storage service and a hardware virtualization service to users according to some examples.

FIG. 10 is a block diagram illustrating an example computing device that can be used in some examples.

### DETAILED DESCRIPTION

The present disclosure relates to methods, apparatus, systems, and non-transitory computer-readable storage media for implementing and utilizing ordered temporary credentials for a zero-trust system implemented in a multi-tenant cloud provider network. According to some examples, an access management (AM) service, such as an Identity and Access Management (IAM) type service, can drastically reduce the risks associated with credential leakage, such as by computing resources executing untrusted code, via enforcing defined orderings of requests being made through use of these credentials.

In cloud provider networks, providing security is an extremely high priority, and thus cloud providers focus on both security of the cloud and within the cloud to provide an extremely secure environment for its users to both store data and build and run applications.

Often, cloud providers operate like a utility, providing general-purpose computing resources to its customers that they, in turn, can configure and utilize in their own specific ways, such as through deploying applications using compute instances, storing data in object stores or databases, or deploying customized machine learning pipelines. However, some cloud providers also construct and provide use-case specific solutions for its customers. In some such cases, these customers may even wish to run or cohost their own “logic” (e.g., code, applications, etc.) along with (or “within”) managed services provided by a cloud provider. However, this reflects a change in paradigm, in that the systems that may have previously been more “backend” systems-which are under the complete control and management of the cloud provider, making them more secure
may now use, invoke, or otherwise interact with customer-provided “untrusted” code in these systems. Accordingly, these previously backend “trusted” systems may then need to be viewed as “zero-trust” systems, as there will now be a possibility of malicious or accidental bad acts occurring due to the inclusion of untrusted customer-provided code into formerly protected spaces.

However, these systems will need to continue to perform their regular basic functions which often involve interacting with other services/systems, e.g., retrieving data from a storage bucket offered by an object storage service, computing results via use of compute instances or functions hosted by other services, writing to a database managed by another service, sending updates to other services' control planes, etc. Accordingly, given their access to other services and systems, it becomes even more important to contain the “blast radius” (e.g., the amount of affected or potentially affected systems) in case of a problem resulting from the introduction of third-party code and the “leak” of credentials used to access these systems, whether from a malicious attack or simply customer error.

Accordingly, as described herein, in some examples an ordering configuration can be specified and provided to an access management service that can be used to ensure that a temporary credential can only be used in a particular defined sequence. Such an ordering configuration can identify an “allowed” order of “calls” or requests made to other systems or services made by a particular source system (or, by a particular “role”), such as one or more computing resources used by a service. This ordering configuration can be generated to match the precise needs of a system, reflecting how it specifically needs to interact with other systems in terms of particular calls, sequencing, and timing, all of which will be unknown to malicious actors. Accordingly, compromised credentials will be exposed as being compromised very rapidly upon their misuse, such as an attacker attempting to use a credential with a non-allowed service, using a non-allowed API request, in a non-allowed order, and/or out of a controlled time window.

Accordingly, examples provide a clear technical benefit in terms of significantly increased computer system security by limiting the ability of unauthorized users to use such credentials, while allowing for the rapid detectability of such attempted uses, without limiting the authorized use of these credentials. Thus, the technical problem of protecting various computing systems from abuse in the case of a compromised temporary credential, as well as detecting such unauthorized uses, can be addressed with the ordering configuration-based credential use authorization techniques disclosed herein.

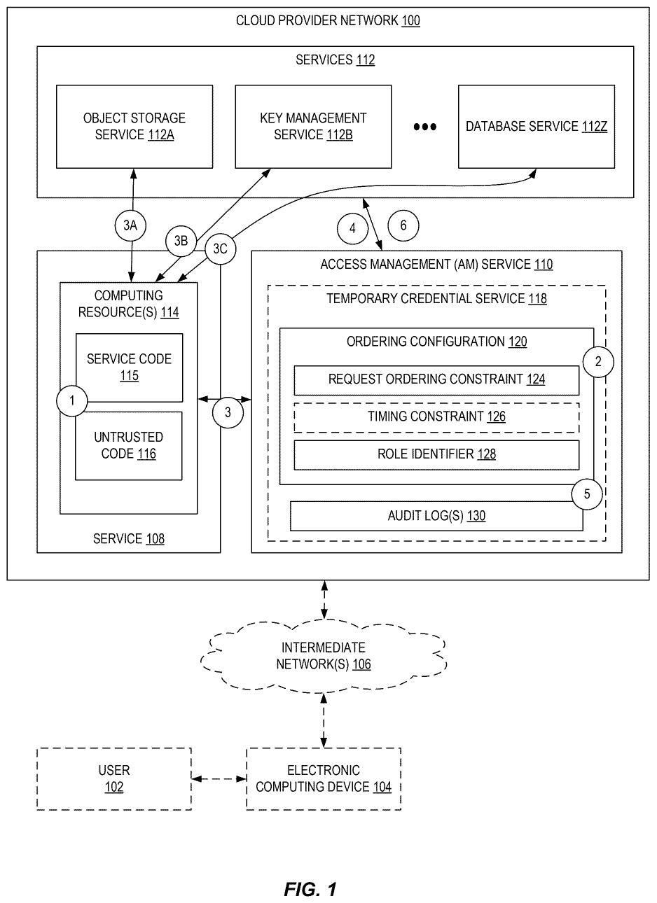

FIG. 1 is a diagram illustrating an environment for implementing and utilizing ordered temporary credentials for a zero-trust system implemented in a multi-tenant cloud provider network according to some examples. As illustrated, a service 108 (providing any of a variety of computing functionalities) implemented in/by a cloud provider network 100 may utilize computing resources 114, such as compute instances (e.g., virtual machines) or containers or serverless functions, to perform tasks. This may include executing service code 115, which is managed or owned by the service itself, to perform “backend” type operations needed to provide the service to its clients. These operations may include interacting with other services 112 of the cloud provider network 100, such as obtaining (e.g., reading or fetching) data objects from a storage service (e.g., object storage service 112A), encrypting or decrypting data using cryptographic key based techniques (e.g., via a key management service 112B), querying/reading and/or writing to a database (e.g., via database service 112Z), utilizing a machine learning model or pipeline via a machine learning service, using a messaging service, or many other types of services 112.

A cloud provider network 100 (also referred to herein as a provider network, service provider network, etc.) provides users with the ability to use one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name System (DNS)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of cloud provider networks 100 can use one or more user accounts that are associated with a customer account, though these terms can be used somewhat interchangeably depending upon the context of use. Cloud provider networks are sometimes “multi-tenant” as they can provide services to multiple different customers using the same physical computing infrastructure; for example, virtual machine instances may be concurrently hosted for different customers using a same underlying physical host computing device.

Users 102 can use an electronic computing device 104 to interact with a cloud provider network 100 across one or more intermediate networks 106 (e.g., the internet) via one or more interface(s), such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the cloud provider network 100 that includes “backend” services supporting and enabling the services that can be more directly offered to customers.

Thus, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

Generally, the traffic and operations of a provider network can broadly be subdivided into two categories: control plane operations carried over a logical control plane and data plane operations carried over a logical data plane. While the data plane represents the movement of user data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes user resources that are implemented on the provider network (e.g., computing instances, containers, block storage volumes, databases, file storage). Data plane traffic generally includes non-administrative operations, such as transferring user data to and from the user resources. The control plane components are typically implemented on a separate set of servers from the data plane servers, and control plane traffic and data plane traffic can be sent over separate/distinct networks.

To provide these and other computing resource services, cloud provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code-typically without the user having any control of or knowledge of the underlying compute instance(s) involved.

As described herein, one type of service that a provider network may provide may be referred to as a “managed compute service” that executes code or provides computing resources for its users in a managed configuration. Examples of managed compute services include, for example, an on-demand code execution service, a hardware virtualization service, a container service, or the like. However, many other types of services exist, such as machine learning services, database services, object storage services, networking services, and the like.

In some scenarios, it may be the case that this illustrated service 108 may allow user-provided (or user-specified) code/software to run alongside of the service code 115, which may provide organization-specific processing of great benefit to particular users. This code, as it is from a third-party, is thus viewed as untrusted code 116 from the standpoint of the cloud provider. Though the service 108 itself can perform automated and/or manual analysis of this untrusted code 116 (e.g., to determine if it includes malicious, unallowed, or otherwise problematic code or properties), in large-scale systems it is difficult or impossible to do extremely thorough, “perfect” analysis of this code without decreasing the “quick to use” benefits of such systems, as such reviews would necessarily take substantial time and potentially involve human involvement. Moreover, even if a system would still involve such time-involved analysis, it is still likely that malicious or simply erroneous may not be discovered, and thus still allowed to run.

Accordingly, service 108 may need to interact with other services 112 of the cloud provider network 100, while still being sufficiently secure to prevent untrusted code 116 from accessing, leaking, using, etc., these other services, as reflected at illustrated circle (1).

In some zero trust system environments, a trusted “control plane” type entity will give (or “vend”) out a temporary credential (e.g., token, key, or the like) to these zero trust systems. These credentials can be scoped to provide a very specific set of permissions to the recipient, so that in case of credential leak, it will not impact multiple users. However, this becomes challenging in many environments, such as when a single computing resource (e.g., a single virtual machine or “compute instance”) might be utilized by multiple different accounts, such as by executing custom code (e.g., untrusted code 116) for one or multiple different accounts. Accordingly, a computing resource 114 such as a compute instance may need to obtain credentials to access or utilize other services 112, and while credentials can be provided for this instance that are scoped to only allow access to those services (or even to only make particular types of requests), these credentials could be leaked or the instance compromised, providing unauthorized access to these multiple services or requests. As one example, in the case of an attack, these credentials could be used by an attacker to perform a denial of service (DoS) or distributed denial of service (DDoS) attack on these other services 112, use the credentials in unanticipated ways (e.g., to confuse the control plane services), use the credentials to exfiltrate data of other users or of the service 108 itself, etc.

Accordingly, examples disclosed herein utilize an ordering constraint on credentials to significantly reduce the ability of credentials to be re-used in non-approved ways. For example, it is now observed that service-vended temporary credentials used by zero trust systems are typically used in a certain discernable order. With knowledge of how these credentials are used in various sequences, control plane services can be configured to detect and even stop attacks altogether.

In some examples, “order of use” type information, defined as an ordering configuration 120, is provided for temporary vended credentials that can be used to ensure that the use of the associated credentials adheres to these defined patterns. For example, a control plane service such as an access management service 110 (which may comprise or include a temporary credential service 118 or other “credential vending service”) may be provided, at illustrated circle (2), an ordering configuration 120 from (or for) the initial service 108, such as by an administrator type persona that manages the service 108.

This ordering configuration 120 can indicate an ordering or sequence of interactions with other services 112 that the service 108 (e.g., the computing resources 114) will utilize, optionally along with other associated limitations, such as a number of times that a particular service will be invoked, a total amount of time needed for making all of the accesses of the sequence, etc. This may occur via an API call to the access management service 118 such as via a “register use cases” call or other onboarding message used to configure the access management service 110 for a particular service (or service subcomponent, such as one or more compute instances it utilizes, referred to here as computing resources 114).

As one example, the request could be formatted according to the following-register-use-case (ordering, role, totalTime)—where the request includes parameters such as an ordering value (e.g., defining an API call type for a particular service, or just an API call type, or just a service, together with an optional “count” indicating how many matching requests are allowed), a “role” value identifying which “role” the use case belongs to (or other identifier that can be used to identify which requesters this use case is to apply to, such as an account identifier, user identifier, function identifier, group identifier, etc.), and an optional “totalTime” value indicating a maximum allowable duration or time window for a credential to be used.

The access management service 110 can then record this ordering configuration 120 in a data structure or data store, where the “ordering” information indicating a sequence of requests/destinations can be stored as a request ordering constraint 124 (or “call sequence”, optionally with associated constraints, such as an allowable numbers of calls for requests in the sequence), the role information can be stored as a role identifier 128 (or set of roles), and the totalTime value can be stored as a timing constraint 126. Using this ordering configuration 120, the access management service 110 can evaluate requests (e.g., from ones of services 112) seeking to determine whether a client's request (e.g., coming from computing resources 114) is authorized, via a provided credential. The access management service 110 can then determine who the associated user or role is associated with the client, determine that the user or role is associated with the ordering configuration 120 (e.g., via matching the role identifier 128), and apply the ordering configuration 120 to determine whether the request (together with any other earlier requests made in association with the credential) satisfies the defined request ordering constraint 124 and optionally timing constraint 126, if it is used. Thus, the access management service 110 (e.g., a temporary credential service 118 or function) can cause authentication and/or authorization decisions made using credentials it vends to only succeed when the ordering and any optional associated limitations, as defined by the ordering configuration 120, are met.

By way of example, a set of “allowed” services 112 to be utilized for a role (and thus, a credential issued for that role) could be defined according to the following ordering configuration 120, indicating that the caller role is authorized to first issue between 1-999 “GetBucket” type requests to an object storage service, then issue between 1-999 “decrypt” type requests to a key management service, and then finally issue a single “putItem” request to a database service. As shown, another limitation is included (via “totalTime”) indicating that all of these requests, in this sequence, must occur within ten minutes of time in order to be valid and thus, satisfy the ordering configuration 120. This configuration could be performed, as shown in FIG. 1, via circles (3A), (3B), and (3C).

The ordering configuration 120 data be stored using a variety of types of storage systems and in a variety of types of formats known to those of skill in the art, such as plaintext, in a key-value format, JSON format, XML format, in a database, etc. In some examples, this ordering configuration 120 data (or a version thereof) can even be included within a credential itself, for example as a session tag, which can allow an entity (e.g., a particular compute resource of the access management service 110) processing the credential to avoid the need to make a separate lookup/query to retrieve it. Notably, in some examples, this information in the credential (or, even the entire credential itself) is obfuscated or encrypted such that only the access management service 110 can derive it in a useful form, and thus neither the service 108 or any other third-party cannot derive it. For example, the ordering configuration 120 can be represented as follows, as a “session tag” supplement to a credential:

```
Credential { ... }
SessionTags {
  Request1: object-storage-service:GetBucket, count(1, 999),
  Request2: key-management-service:decrypt, count(1, 999),
  Request3: database-service:putItem, count(1),
  totalTime: 10 minutes
}
```

Accordingly, as part of performing its typical operations, a service entity (e.g., a compute instance) needing to interact with these other services may seek a temporary credential for use in passing to these other services 112. This computing resource 114, as shown by circle (3), may thus make a call to an access management service 110 to obtain temporary credentials (e.g., via a Generate TempCredentials type API call, an “assume role” type API call, or the like), where the access management service 110 can perform its authentication and/or authorization tasks to determine if this request is to be performed, and if so, create and provide the calling compute instance with a set of temporary credentials, which itself is associated with a session. In some examples, this set of temporary credentials includes (or is) a token, which is encrypted in whole or in part, to protect its contents from being understood outside of the access management service 110.

In some examples, the access management service 110 is aware of who the calling entity is and what credentials it seeks (or, which role it seeks to assume), which may be provided in this request. The access management service 110 therefore knows what the associated ordering configuration 120 is- and thus, the ordering (or sequence) of services and/or calls imposed for this entity is. Accordingly, the credential may be formed to include the ordering configuration 120 itself, reflecting the set of services and/or calls that are allowed and any other imposed constraints (e.g., timing constraints), though in other examples, this information (in a same or different format) may simply be stored by access management service 110 in other ways. In some examples, this credential is encrypted by the access management service 110 such that some or all of the data it provides is not viewable or discernable by examination of just the credential itself.

After a credential is provided back to the computing resources 114, the compute resource(s) 114 may pass the temporary credential (or token, etc.) along with its requests to access other services 112 as reflected by circles (3A), (3B), and (3C). For example, the compute resource may pass the credential along with a “GetBucket” request to an object storage service as reflected by circle (3A). As reflected in the example provided herein involving three types of requests, this request is proper according to the sequence of operations as defined by the configuration, so it should be allowed. Thus, for example, the object storage service 112A may receive the request (with credential) and pass the credential on to the access management service to have it determine whether the request is allowable/authorized for the invoking client, as shown at circle (4).

At circle (5), the access management service 110 can then perform a variety of authorization and/or authentication tasks for this request based on other portions of the request and/or credential, which may include operations such as verifying the propriety of the credential (e.g., is it properly signed/encrypted), is the credential being used for/by the same entity for which it was issued, does the credential indicate that the particular credential-holder is defined as being able to access that service and/or invoke the requested operation, etc. The access management service 110 may also authorize and/or authenticate the calling service itself, e.g., object storage service 112A.

Additionally, in some examples, the access management service 110 can check the ordering configuration 120, defined for the session (corresponding to the temporary credential), to ensure that the request ordering constraint 124 ordering and any other limitations (e.g., timing constraint 126) are met by this request (assuming that the request is allowed).

To be able to understand the context of the desired request within the life of the credential/session for the purpose of evaluating the ordering configuration 120, in some examples the access management service 110 populates an audit log 130 to “track” the usage of the credential. The audit log 130 can be used to record a history of calls made for the session (e.g., using the credential), and thus may track, for each request, an identifier of the targeted service, the utilized call type (e.g., the API request name/method), a timestamp associated with the sending of the request (or receipt of the request), etc. This may occur upon receipt of the request from the target service(s) 112, e.g., as described with regard to circle (4), to enable the access management service 110 to view the entire chain of requests (including the desired request) and more simply determine if the latest request, if allowed, would cause a problem.

This audit log 130 information may be stored in a data store such as a database, in a text file, or similar data structure. By way of example, updating the audit log 130 may include adding a timestamp to the data structure, e.g., associated with a time the request was made by the compute instance, received at the object storage service, and/or the auth request was received at the access management service), that indicates which type of request was made, which type of service was called, etc.

As one simple example, the following audit log data structure could be used, where a first entry is made indicating that the first type of request (defined in the ordering configuration 120 as a “object-storage-service: GetBucket” request) was made at a particular time, reflected here as a “timestamp1.”

Audit log {
Request1: <timestamp1>
}

The access management service may thus determine if the call sequence, of the ordering configuration 120, allows the request. In this example, we assume that no other calls have been made for the session, and thus, because this is a request that (a) matches the “Request1” specification, (b) matches the “count” limitation for the request (where between 1-999 calls can be made), and (c) satisfies the total time requirement (where all calls must occur within 10 minutes), the access management service 110 may determine that the request is allowed (or authorized), and may send a message back at circle (6) indicating that the request is authorized as its response to the object storage service 112A.

It could then be the case that the compute resource 114 issues this same type of call three more times within the next few seconds, where all are allowed per the defined ordering configuration 120, which allows up to 999 of the “Request1” calls to occur, optionally with calls to the successive services, collectively within 10 minutes. This could result in the following audit log data structure:

```
Audit log {
  Request1: <timestamp1>,
  Request1: <timestamp2>,
  Request1: <timestamp3>,
  Request1: <timestamp4>,
}
```

Accordingly, each time one of these requests is processed by the access management service 110 (e.g., for authentication and/or authorization purposes), the access management service 110 updates and then analyzes the audit log 130 against the defined ordering configuration 120 to determine whether all specified conditions or limitations are satisfied. In this case, the access management service 110 determines that multiple requests of the first type have been recorded, which are of a number less than the defined maximum (of 999), and all of which are occurring within the allowable time range (e.g., 10 minutes, based on computing a difference between timestamp4 and timestamp1).

Should the computing resource 114 then seek to issue a “decrypt” call to the key management service 112B, assuming the time constraint is still satisfied, it should be approved by the access management service 110, as that would match the request ordering constraint 124 pattern as specified by the ordering configuration 120. Thus, the audit data log could appear as follows:

```
Audit log {
  Request1: <timestamp1>,
  Request1: <timestamp2>,
  Request1: <timestamp3>,
  Request1: <timestamp4>,
  Request2: <timestamp5>
}
```

However, if the computing resource 114 and/or the credential was in some way compromised—e.g., due to malicious actions of an attacker, or simply error in the untrusted code 116—the credential may then be used to attempt to access some other service and/or use some other type of call. For example, an attacker in possession of the credential may attempt to “go back” to making calls of the first type—e.g., “getBucket” to attempt to steal data. As another example, an attacker may seek access to other services 112.

In this case, upon issuing a call with the credential according to the Request1 definition (again with regard to circle (3A)), the recipient object storage service 112A may pass the credential on as part of authentication and/or authorization at circle (4) to the access management service 110, which may update and use the audit log 130 at circle (5) to analyze the credential and request.

In this instance, even though the credential generally allows this type of call to the object storage service 112A, this request can be denied due to the request causing the call pattern to no longer match the request ordering constraint 124 from the ordering configuration 120. In this example case, as at least one Request2 has already been received for this credential, it can be determined that it is out-of-order to attempt to again issue a Request1 or issue any other type of request for any other type of destination service, aside from a request matching the Request2 or Request3 definition. Notably, this sequence would be entirely difficult for an attacker to figure out, as the existence of this protection scheme is not visible, the ordering configuration 120 information is stored separately, there are many types of calls and services that could be interacted with, and many permutations of ordering configuration 120 that can be defined.

Accordingly, the access management service 110 at circle (6) can return some sort of error or failure message to the object storage service 112A, preventing improper access. Additionally, or alternatively, the credential can automatically be invalidated for future use (e.g., by the access management service 110), thus increasing security by quickly preventing further attempted use of the credential, while potentially still allowing the “legitimate” application to again obtain a new temporary credential and continue its legitimate operation. In some examples, other responsive actions can be performed, such as generating alert messages or logs, notifying the associated user (e.g., of code being executed by the compute resource 114), notifying the service 108 (that itself is providing this service to the user) and/or its administrator, implementing enhanced security or scrutiny on further calls from the source computing resource 114 (e.g., a compute instance) or source using the credential, creating “alarms” for a security dashboard, emitting special metrics related to the incident, invalidating the credential, or the like. Accordingly, substantially enhanced security is provided while still allowing legitimate operations in the event of a detected issue, while also simply allowing this deployment possibility to exist, i.e., allowing for untrusted code execution within a sensitive environment.

Accordingly, even if an attacker even gets access to these credentials and attempts to make calls in any order except the extremely specific one listed in the ordering configuration 120, these requests will fail and the system can immediately detect the compromise of the credential (and react accordingly).

Additionally, these techniques can provide substantial benefit to large-scale distributed systems, where there may be many instances of service code 115 in operation. In some examples, the credentials issued to these different instances can be uniquely tied to each specific instance, and thus the different requests issued by these instances at similar or different points of time will not be confused or impact the request ordering analysis for others of the instances. Accordingly, requests involving a first instance can beneficially be tracked separately from requests involving a second instance, despite the fact that these instances may be executing the same service code 115 to perform the same tasks for the service 108.

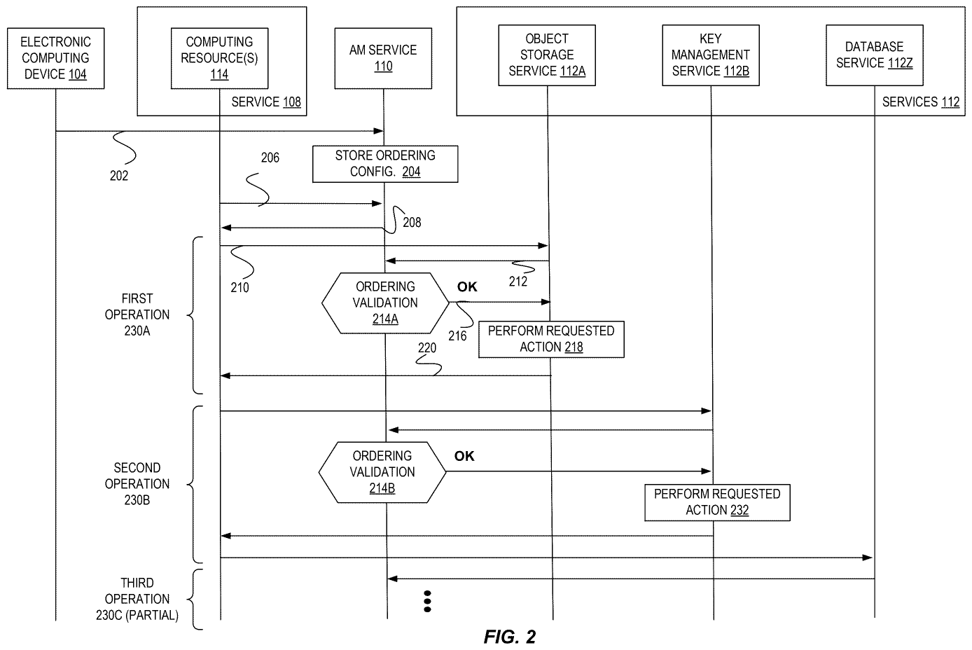

FIG. 2 is a sequence-type diagram illustrating ordering configuration compliant ordered temporary credential utilization for a zero-trust system according to some examples. As described herein, in some examples an administrative type persona may define an ordering configuration, via use of electronic computing device 104 to send, to the access management service 110, data for the ordering configuration. This may occur via an API call, via use of a console type application or other graphical user interface, or via a variety of means, where the data is sent via message 202. In some examples, the ordering configuration can be crafted based on viewing a previous history of the associated computing resources, whereby the user may view previous calls made over time and use this information to define a sequence (and associated conditions), such as by selecting several calls from an ordered list and placing those requests into an ordering configuration. Additionally, or alternatively, the access management service 110 may attempt to identify patterns for an ordering configuration on its own, e.g., using a rule-based approach, heuristic based approach, machine learning based approach, etc., to identify recurring patterns of calls, which can be confirmed by the user to result in an ordering configuration. At block 204, the access management service 110 can store the ordering configuration in a data structure or data store.

Thereafter, when the computing resources 114 are performing their typical operations (e.g., by executing service code 115), a call 206 may be made to obtain a temporary credential from the access management service 110, which can generate a credential as typical and return it via message 208 to the computing resources 114. In some examples, this credential may include ordering configuration type data, which may be encrypted or otherwise obfuscated; however, the inclusion of ordering configuration type data may not be strictly necessary in various implementations.

The computing resources 114 may then seek to perform a first operation 230A involving a first service—here, an object storage service 112A. First, a request 210 is transmitted to the object storage service 112A with the credential. The recipient service, object storage service 112A, can then seek to authenticate and/or authorize the request by sending a message 212 to access management service 110 that includes the credential (and optionally some or all of the contents of request 210).

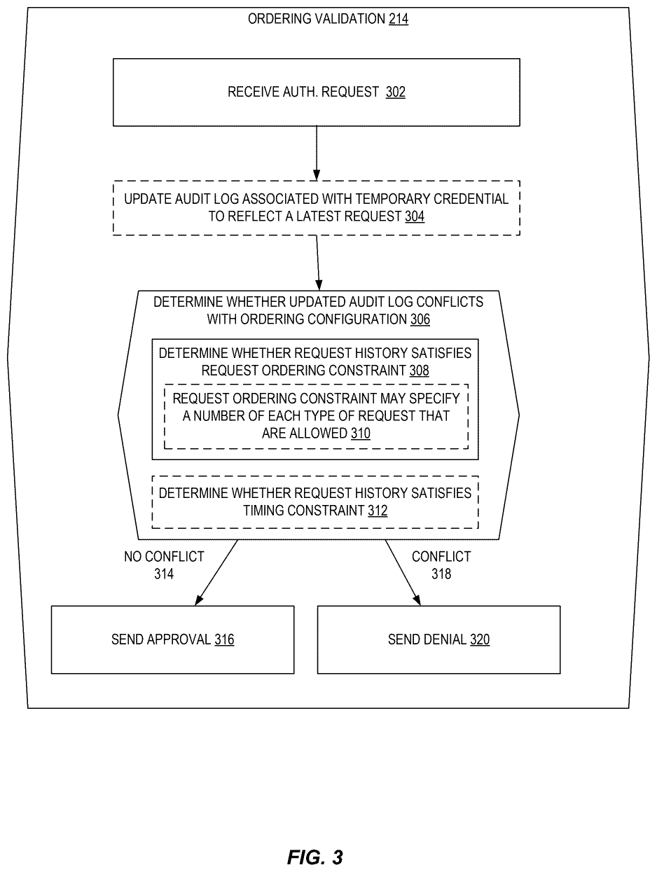

The access management service 110 may perform an ordering validation 214A process as described herein, based on the ordering configuration (associated with the role used by the computing resources 114, and/or associated with the credential), to determine whether the call satisfies the ordering configuration. For example, FIG. 3 is an example diagram illustrating operations for ordering configuration validation for requests utilizing ordered temporary credentials according to some examples. As shown, ordering validation 214 can include, upon receipt of an authorization request 302, updating the audit log (associated with the temporary credential) to reflect this new request at block 304, and using the audit log, at decision block 306, to determine whether this access pattern (as reflected by the audit log) conflicts with the ordering configuration. However, in some examples, block 304 need not be performed at this point, as the “new” request can simply be considered as being part of a proposed call sequence, where the new request can be added to the audit log at a later point, e.g., after it is approved.

Block 306 can include, for example, block 308 to determine whether the request history (captured in the audit log) satisfied the request ordering constraint 124. This can include, for example, determining if the requests logged in the audit log are in the same order as laid out in the call sequence specified by the request ordering constraint 124.

In some examples, this constraint may specify a number of times each type of request (in the sequence) can be invoked as reflected by optional block 310, and thus, it can be the case that multiple consecutive invocations of a request may be allowable according to the sequence.

In some examples block 308 also includes determining whether the request history, as provided by the audit log, satisfies a timing constraint of the ordering configuration (that may optionally be provided). This can include determining what the allowable time window or range is (e.g., any 10-minute time window, a particular range of times in a day, etc.), and determining based on the audit log whether all previously seen requests as well as the current request satisfy this timing constraint. This can include, for example, determining a time difference between a first request and a last request, and determining if this time difference is less than a defined time limit of the ordering configuration. Additionally, or alternatively, this could include determining a time window based on the ordering configuration (e.g., requests must be between 9-10 am) and determining whether every single request captured in the audit log is within this window.

If no conflict is determined to exist between the audit log and the ordering configuration, then path 314 is followed and an approval can be sent at block 316 (assuming any other authentication and/or authorization processes have similarly been approved), whereas if a conflict is found, path 318 is followed and a denial is sent at block 320.

Returning to FIG. 2, in this example, we assume that the request is allowable, and an approval message 216 is sent to the object storage service 112A, which performs the requested action(s) at block 218 and returns a response via message 220 to computing resources 114.

This process may continue for a second operation 230B (where a second requested action is performed at block 232 by the key management service 112B), as well as for a (partially illustrated) third operation 230C, and possibly other operations as allowed by the defined ordering configuration.

Thus, the typical flow of operations occurs unimpeded by the protections provided by the ordering configuration, and the computing resources 114 can operate normally without any substantial increased delay. However, in the case of a credential leak or misuse, the system can quickly detect the issue and act accordingly, typically even before any improper accesses are even made.

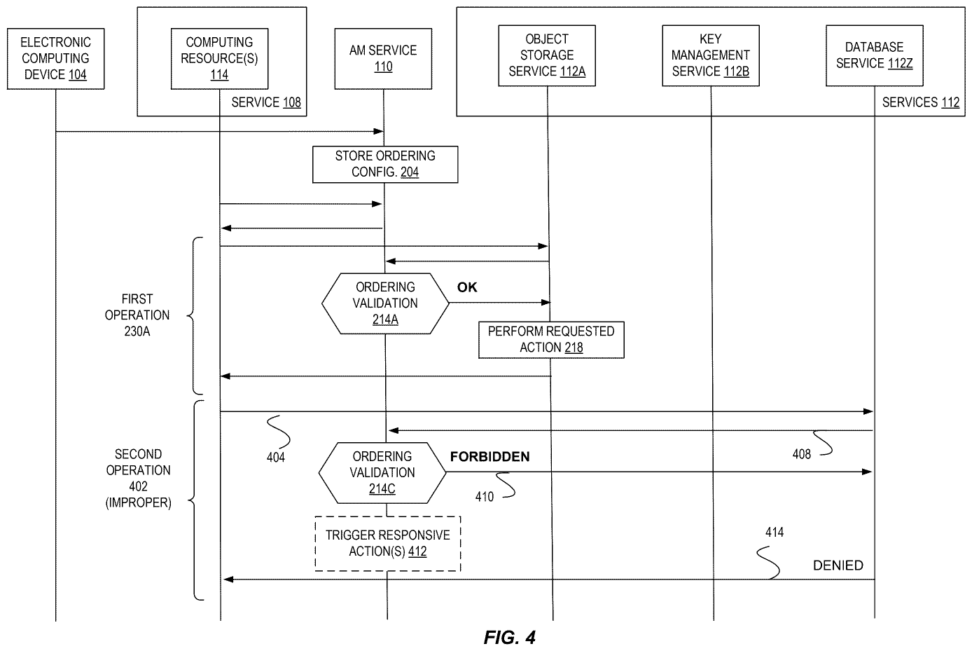

For example, FIG. 4 is a sequence-type diagram illustrating ordering configuration non-compliant ordered temporary credential utilization for a zero-trust system according to some examples. In this example, we assume that a first operation 230A is performed using a credential as also indicated in FIG. 2. However, after this point, a second, improper operation 402 is attempted. In this example, the improper operation 402 is executed by the computing resources 114 (e.g., due to a code exploit, compromise, etc.), though in other examples it may be initiated by a separate entity (e.g., due to an exfiltration of the credential).

Regardless, a request 404 to access another service is sent-here, to database service 112Z. Even though this service may be approved within the ordering configuration, in this example, we assume that the access is out-of-order. Upon the database service 112Z seeking to authorize (and optionally authenticate) the request via message 408, the ordering validation block 214C may be performed by the access management service 110, which will detect that this request causes the sequence of requests issued via the credential to violate the defined sequence/ordering information of the ordering configuration. Accordingly, a denial message 410 (here, reflecting that the request is “forbidden”) is returned to the database service 112Z, causing it to send a denial/rejection message 414 back to the requesting client-here, the computing resources 114.

Upon the detection of the ordering issue via block 214C, the access management service 110 may optionally trigger one or more other responsive actions, as reflected by block 412. For example, the access management service 110 may update its records to invalidate the credential. As another example, the access management service 110 may send messages or data to other systems, such as the service 108 or a logging service or dashboard system or central cloud database, indicating that the issue was detected and thus to “alert” other services, entities, or users of the issue, which may further invoke other responsive security-related actions (e.g., on the part of the service 108, the cloud provider network 100, database service 112Z, etc.), such as halting certain processing, terminating certain computing resources 114, protecting resources, blocking traffic, collecting additional metrics or metadata (for later research or investigation), or the like.

Flexibly, the disclosed techniques can be adapted to support a variety of different use cases. For example, it may be the case that service 108 may update its service code 115 to thereby utilize a different sequence of requests to other services 112. To prevent problems with the rollout of this code (e.g., to potentially a large fleet of compute resources), examples can allow for different versions of a ordering configuration 120 to exist at a single point of time.

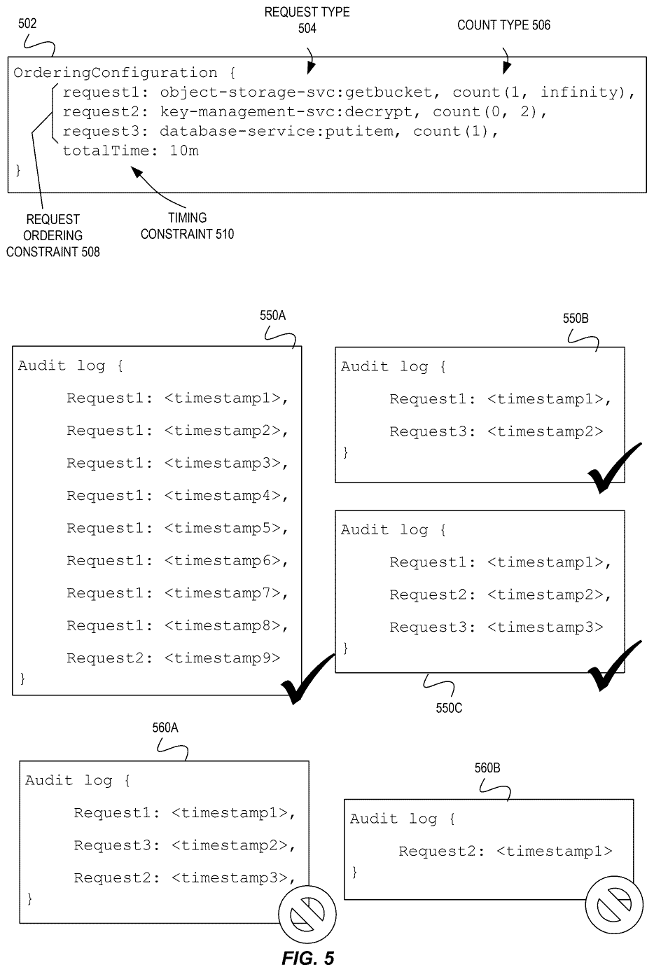

For example, FIG. 5 is a diagram illustrating an exemplary ordering configuration 502 and various compliant audit logs 550A-550C and non-compliant audit logs 560A-560B according to some examples. As shown, the exemplary ordering configuration 502 object provides a sequence of three different requests as part of a request ordering constraint 508. A first “request item” in the sequence allows one or more (to infinity, per the count type 506) “get bucket” API method calls to an object storage service (which together constitute the request type 504). The second request item is for a “decrypt” API call to a key management service, where the count type allows either zero, one, or two of these calls to be made. Additionally, the third request item is for a “put item” API call to a database service, where only one can be made. The exemplary ordering configuration 502 further includes a timing constraint, where this sequence defined by the request ordering constraint 508 must be completed within a defined time window of ten minutes.

Based on this exemplary ordering configuration 502, several example audit logs are shown that are compliant and non-compliant. First, audit log 550A is compliant with eight Request1 calls (“get bucket” calls made to an object storage service) and then a single Request2 call (a “decrypt” call made to a key management service). Additionally, audit log 550B is compliant, with a single Request1 call and a single Request3 call—per the count type 506 of “count (0, 2)” it is allowed to have zero Reqeust2 calls. Finally, audit log 550C is compliant with a single Request1, followed by a single Request2, followed by a single Request3.

However, a non-compliant audit log 560A is shown with requests, which still are being made to approved services and are of an appropriate request type, that are out of order and thus collectively violate the order provided by the request ordering constraint 508. As shown, the problem is not going from Request1 to Request2 (due to the count type of zero-to-two requests allowed for Request2), but rather continuing to use the credential thereafter for Request2, which should have occurred prior to Request3.

Additionally, another non-compliant audit log 560B is shown that simply includes a call to Request2, which per the exemplary ordering configuration 502 could not happen until after one or more Request1 type calls are made, again despite the fact that Request2 type calls are valid in some circumstances as proscribed by the request ordering constraint 508.

Additionally, in some examples, versioning information can be used to support changes to the calling entity. For example, if an update to the code executed by the compute instance is made that causes a new ordering to be needed, another call to the access management service can be made to create a new “version” of the ordering configuration, which can be marked with a next “version” identifier (e.g., version 2.0). Thus, in some examples, one or multiple versions of a same ordering configuration can be supported at a point in time, which can allow for continued operation across a fleet (e.g., where the code may be slowly updated over time), allow for new versions of this code to be tested, or the like. In some examples, the access management service may further allow for particular versions to be “unregistered”, such as when a deployment of code to a fleet has been completed and validated, whereby the “old” version (or versions) are marked as invalid, deleted, etc.

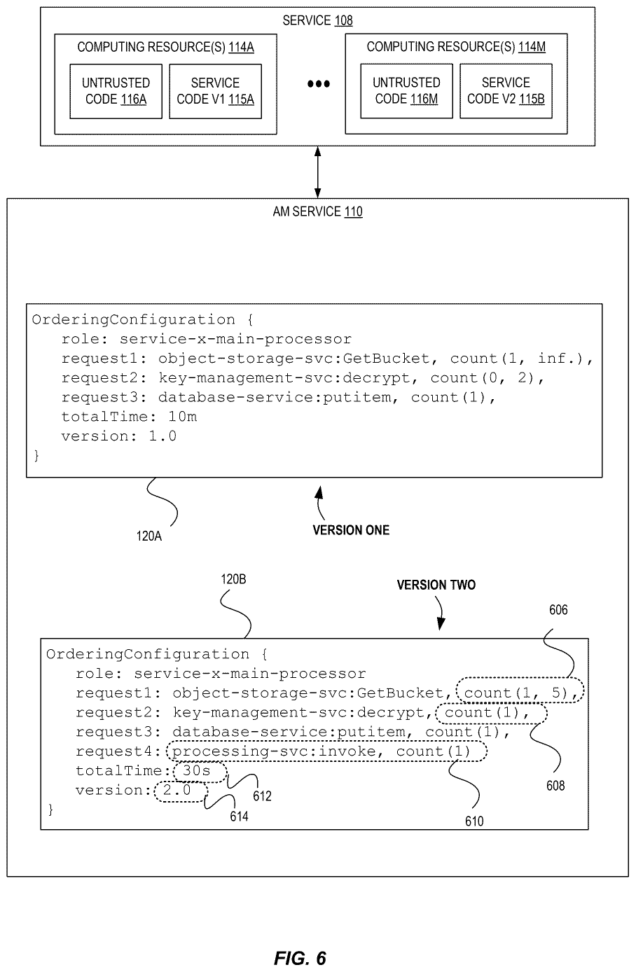

FIG. 6 is a diagram illustrating multi-version ordering configuration support for supporting multiple concurrent service code variants according to some examples. As shown, a user 102 may have, at a point in time, multiple variants of service code in use across a fleet-here, a first version of service code 115A executed by a first set of computing resources 114A as well as a second version of service code 115B executed by a second set of computing resources 114B. This can happen for a variety of reasons, such as a staged rollout of updates to this code, the use of slightly different variants of components (implemented by these computing resources), or the like. To prevent either the first or second versions of this code from failing due to them utilizing call sequences, examples can support versioned ordering configurations. As shown, the access management service 110 can have registered a first version of the ordering configuration 120A as well as a second version of the ordering configuration 120B, which can be used concurrently to evaluate accesses made by different versions of service code 115, where both may be using a same “role” for these accesses, here shown with a role identifier of “service-x-main-processor.”

As shown, the second version of the ordering configuration 120B includes several differences, such as a different count 606 for request1 (now only allowing between 1-5 calls, instead of 1-infinity), a different count 608 for request2 (now allowing only 1 call, instead of 0-2), a different request type for a new request in the sequence (here, a single “invoke” call to a processing service is allowed after request3), a new time constraint 612 (of thirty seconds instead of ten minutes). This ordering configuration 120B also includes a different version identifier-here, 2.0 instead of 1.0.

Various approaches can be used to differentiate between which ordering configuration is to be utilized. In some examples, a request made to obtain a credential may include an identifier associated with the version, which can possibly be “embedded” or otherwise reflected in the credential itself. This can be detected by the access management service 110 and used when fetching the ordering configuration to obtain the proper version. Additionally, or alternatively, a separate process between the access management service 110 and the involved service 108 can occur, whereby the service 108 can transmit identifiers of which computing resources 114 pertain to which version of the ordering configuration 120. However, many other techniques exist that are known or derivable by those of skill in the art based on the particulars of the implementation, and thus it is to be understood that these approaches are merely exemplary.

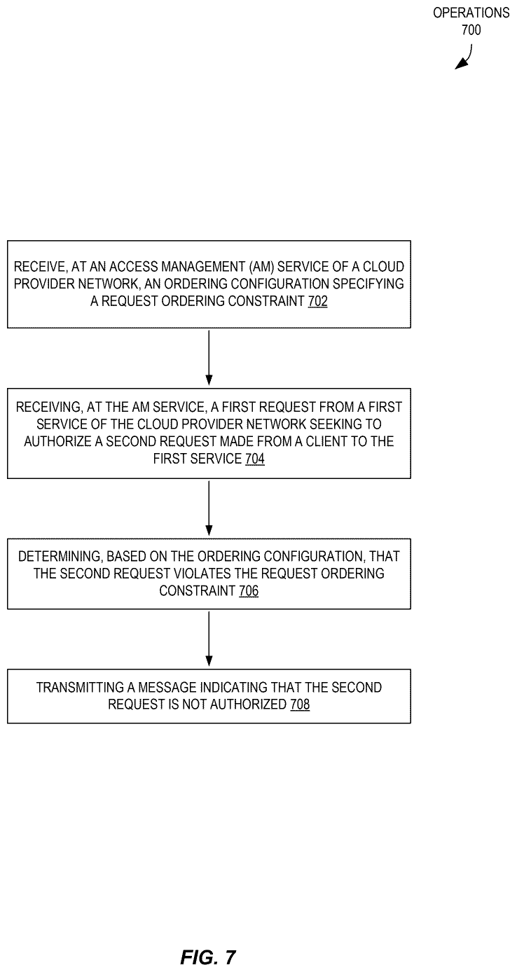

FIG. 7 is a flow diagram illustrating operations 700 of a method for implementing and utilizing ordered temporary credentials for a zero-trust system implemented in a multi-tenant cloud provider network according to some examples. Some or all of the operations 700 (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations 700 are performed by the access management service 110 and/or temporary credential service 118 of the other figures.

The operations 700 include, at block 702, receiving, at an access management service (e.g., an identity and access management (IAM) service) of a cloud provider network, an ordering configuration specifying a request ordering constraint. The operations 700 further include, at block 704, receiving, at the access management service, a first request from a first service of the cloud provider network seeking to authorize a second request made from a client to the first service.

The operations 700 further include, at block 706, determining, based on the ordering configuration, that the second request violates the request ordering constraint; and at block 708, transmitting a message indicating that the second request is not authorized.

In some examples, the operations 700 further include receiving, at the access management service, a first credential from the first service, wherein the first credential was provided by the client with the second request, wherein the determining that the second request violates the request ordering constraint is further based on the first credential. In some examples, the ordering configuration includes a version identifier and the operations 700 further include identifying, by the access management service based on the first credential, a version of ordering configuration, from multiple candidate versions, to be used, wherein the version corresponds to the version identifier; and obtaining the configuration information for use as part of the determining that the second request violates the request ordering constraint. In some examples, the ordering configuration further includes a role identifier of a role, and the operations 700 further include receiving, at the access management service, a request originated by the client to assume the role; generating the first credential; and transmitting the first credential to the client, wherein the ordering configuration is selected for use in the determining based on the first credential.

In some examples, the request ordering constraint identifies a plurality of request types in an order, wherein each of the plurality of request types identifies a service of the cloud provider network and a request method supported by that service. In some examples, a first request type of the plurality of request types, within the ordering configuration, is associated with a count type indicating a number or range of requests that are allowed for the first request type. In some examples, the number or range of requests allows at least two requests of the first request type.

In some examples, the ordering configuration further specifies a maximum allowable time for requests to be made according to the request ordering constraint. In some examples, the operations 700 further include determining, based on the ordering configuration, that a third request does not violate the request ordering constraint but does violate the maximum allowable time; and transmitting a second message indicating that the third request is not authorized.

In some examples, the second request was originated by service code of the first service executed by a compute instance, wherein the compute instance also executes untrusted code provided or selected by a user of the cloud provider network.

In some examples, the operations 700 further include generating an alarm indicating that the second request violated the request ordering constraint. The alarm may comprise a warning or error message that is transmitted to another system or account, or may comprise an icon or change to a graphical user interface that is presented to a user (e.g., an administrator), etc.

In some examples, the ordering configuration is a first version, and the operations 700 further include: determining, using the first version of the ordering configuration during a period of time corresponding to a migration of service code, whether a first set of requests associated with an initial version of the service code violate the request ordering constraint; and determining, using a second version of the ordering configuration, during the same period of time, whether a second set of requests associated with a migrated version of the service code violate a second request ordering constraint specified by the second version of the ordering configuration.

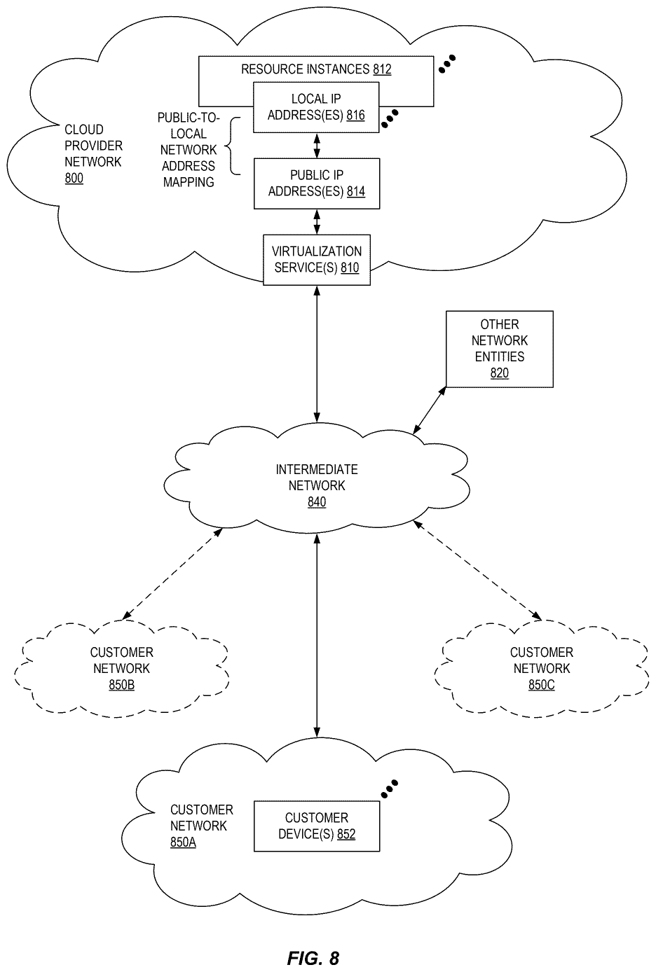

FIG. 8 illustrates an example provider network (or “service provider system”) environment according to some examples. A provider network 800 can provide resource virtualization to customers via one or more virtualization services 810 that allow customers to purchase, rent, or otherwise obtain instances 812 of virtualized resources, including but not limited to computation and storage resources, implemented on devices within the provider network or networks in one or more data centers. Local Internet Protocol (IP) addresses 816 can be associated with the resource instances 812; the local IP addresses are the internal network addresses of the resource instances 812 on the provider network 800. In some examples, the provider network 800 can also provide public IP addresses 814 and/or public IP address ranges (e.g., Internet Protocol version 4 (IPv4) or Internet Protocol version 6 (IPv6) addresses) that customers can obtain from the provider 800.

Conventionally, the provider network 800, via the virtualization services 810, can allow a customer of the service provider (e.g., a customer that operates one or more customer networks 850A-850C (or “client networks”) including one or more customer device(s) 852) to dynamically associate at least some public IP addresses 814 assigned or allocated to the customer with particular resource instances 812 assigned to the customer. The provider network 800 can also allow the customer to remap a public IP address 814, previously mapped to one virtualized computing resource instance 812 allocated to the customer, to another virtualized computing resource instance 812 that is also allocated to the customer. Using the virtualized computing resource instances 812 and public IP addresses 814 provided by the service provider, a customer of the service provider such as the operator of the customer network(s) 850A-850C can, for example, implement customer-specific applications and present the customer's applications on an intermediate network 840, such as the Internet. Other network entities 820 on the intermediate network 840 can then generate traffic to a destination public IP address 814 published by the customer network(s) 850A-850C; the traffic is routed to the service provider data center, and at the data center is routed, via a network substrate, to the local IP address 816 of the virtualized computing resource instance 812 currently mapped to the destination public IP address 814. Similarly, response traffic from the virtualized computing resource instance 812 can be routed via the network substrate back onto the intermediate network 840 to the source entity 820.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 800; a customer can then assign their allocated public IP addresses to particular resource instances allocated to the customer. These public IP addresses can be referred to as customer public IP addresses, or simply customer IP addresses. Instead of being assigned by the provider network 800 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

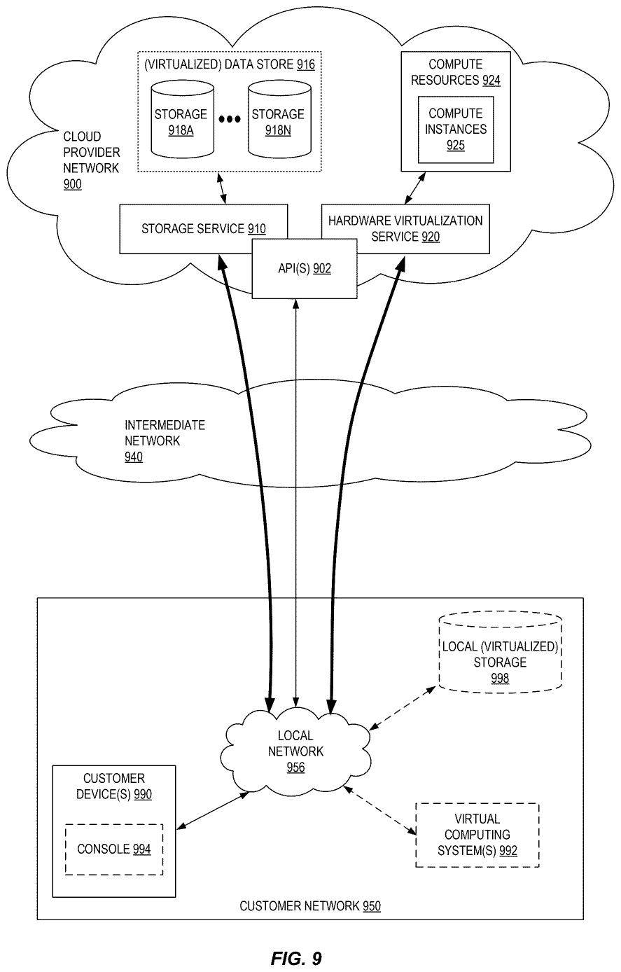

FIG. 9 is a block diagram of an example provider network environment that provides a storage service and a hardware virtualization service to users, according to some examples. A hardware virtualization service 920 provides multiple compute resources 924 (e.g., compute instances 925, such as VMs) to users. The compute resources 924 can, for example, be provided as a service to users (or “customers”) of a provider network 900 (e.g., to a customer that implements a customer network 950). Each computation resource 924 can be provided with one or more local IP addresses. The provider network 900 can be configured to route packets from the local IP addresses of the compute resources 924 to public Internet destinations, and from public Internet sources to the local IP addresses of the compute resources 924.

The provider network 900 can provide the customer network 950, for example coupled to an intermediate network 940 via a local network 956, the ability to implement virtual computing systems 992 via the hardware virtualization service 920 coupled to the intermediate network 940 and to the provider network 900. In some examples, the hardware virtualization service 920 can provide one or more APIs 902, for example a web services interface, via which the customer network 950 can access functionality provided by the hardware virtualization service 920, for example via a console 994 (e.g., a web-based application, standalone application, mobile application, etc.) of a customer device 990. In some examples, at the provider network 900, each virtual computing system 992 at the customer network 950 can correspond to a computation resource 924 that is leased, rented, or otherwise provided to the customer network 950.

From an instance of the virtual computing system(s) 992 and/or another customer device 990 (e.g., via console 994), the customer can access the functionality of a storage service 910, for example via the one or more APIs 902, to access data from and store data to storage resources 918A-918N of a virtual data store 916 (e.g., a folder or “bucket,” a virtualized volume, a database, etc.) provided by the provider network 900. In some examples, a virtualized data store gateway (not shown) can be provided at the customer network 950 that can locally cache at least some data, for example frequently accessed or critical data, and that can communicate with the storage service 910 via one or more communications channels to upload new or modified data from a local cache so that the primary store of data (the virtualized data store 916) is maintained. In some examples, a user, via the virtual computing system 992 and/or another customer device 990, can mount and access virtual data store 916 volumes via the storage service 910 acting as a storage virtualization service, and these volumes can appear to the user as local (virtualized) storage 998.

While not shown in FIG. 9, the virtualization service(s) can also be accessed from resource instances within the provider network 900 via the API(s) 902. For example, a customer, appliance service provider, or other entity can access a virtualization service from within a respective virtual network on the provider network 900 via the API(s) 902 to request allocation of one or more resource instances within the virtual network or within another virtual network.

### Illustrative Systems

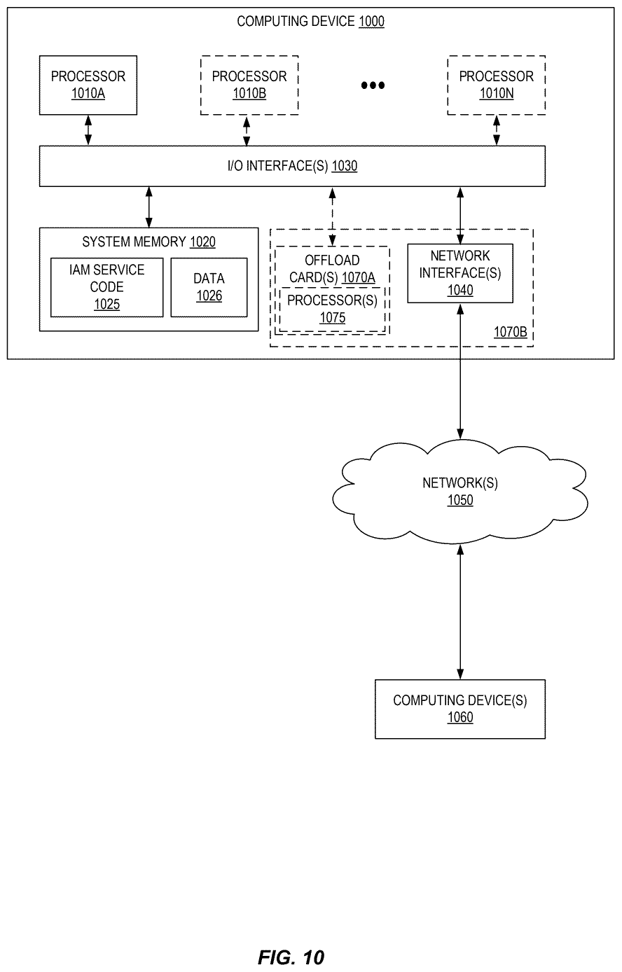

In some examples, a system that implements a portion or all of the techniques described herein can include a general-purpose computer system, such as the computing device 1000 (also referred to as a computing system or electronic device) illustrated in FIG. 10, that includes, or is configured to access, one or more computer-accessible media. In the illustrated example, the computing device 1000 includes one or more processors 1010 coupled to a system memory 1020 via an input/output (I/O) interface 1030. The computing device 1000 further includes a network interface 1040 coupled to the I/O interface 1030. While FIG. 10 shows the computing device 1000 as a single computing device, in various examples the computing device 1000 can include one computing device or any number of computing devices configured to work together as a single computing device 1000.

In various examples, the computing device 1000 can be a uniprocessor system including one processor 1010, or a multiprocessor system including several processors 1010 (e.g., two, four, eight, or another suitable number). The processor(s) 1010 can be any suitable processor(s) capable of executing instructions. For example, in various examples, the processor(s) 1010 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 1010 can commonly, but not necessarily, implement the same ISA.

The system memory 1020 can store instructions and data accessible by the processor(s) 1010. In various examples, the system memory 1020 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 1020 as access management service code 1025 (e.g., executable to implement, in whole or in part, the access management service 110) and data 1026.

In some examples, the I/O interface 1030 can be configured to coordinate I/O traffic between the processor 1010, the system memory 1020, and any peripheral devices in the device, including the network interface 1040 and/or other peripheral interfaces (not shown). In some examples, the I/O interface 1030 can perform any necessary protocol, timing, or other data transformations to convert data signals from one component (e.g., the system memory 1020) into a format suitable for use by another component (e.g., the processor 1010). In some examples, the I/O interface 1030 can include support for devices attached through various types of peripheral buses, such as a variant of the Peripheral Component Interconnect (PCI) bus standard or the Universal Serial Bus (USB) standard, for example. In some examples, the function of the I/O interface 1030 can be split into two or more separate components, such as a north bridge and a south bridge, for example. Also, in some examples, some or all of the functionality of the I/O interface 1030, such as an interface to the system memory 1020, can be incorporated directly into the processor 1010.

The network interface 1040 can be configured to allow data to be exchanged between the computing device 1000 and other computing devices 1060 attached to a network or networks 1050, such as other computer systems or devices as illustrated in FIG. 1, for example. In various examples, the network interface 1040 can support communication via any suitable wired or wireless general data networks, such as types of Ethernet network, for example. Additionally, the network interface 1040 can support communication via telecommunications/telephony networks, such as analog voice networks or digital fiber communications networks, via storage area networks (SANs), such as Fibre Channel SANs, and/or via any other suitable type of network and/or protocol.

In some examples, the computing device 1000 includes one or more offload cards 1070A or 1070B (including one or more processors 1075, and possibly including the one or more network interfaces 1040) that are connected using the I/O interface 1030 (e.g., a bus implementing a version of the Peripheral Component Interconnect-Express (PCI-E) standard, or another interconnect such as a QuickPath interconnect (QPI) or UltraPath interconnect (UPI)). For example, in some examples the computing device 1000 can act as a host electronic device (e.g., operating as part of a hardware virtualization service) that hosts compute resources such as compute instances, and the one or more offload cards 1070A or 1070B execute a virtualization manager that can manage compute instances that execute on the host electronic device. As an example, in some examples the offload card(s) 1070A or 1070B can perform compute instance management operations, such as pausing and/or un-pausing compute instances, launching and/or terminating compute instances, performing memory transfer/copying operations, etc. These management operations can, in some examples, be performed by the offload card(s) 1070A or 1070B in coordination with a hypervisor (e.g., upon a request from a hypervisor) that is executed by the other processors 1010A-1010N of the computing device 1000. However, in some examples the virtualization manager implemented by the offload card(s) 1070A or 1070B can accommodate requests from other entities (e.g., from compute instances themselves), and cannot coordinate with (or service) any separate hypervisor.

In some examples, the system memory 1020 can be one example of a computer-accessible medium configured to store program instructions and data as described above. However, in other examples, program instructions and/or data can be received, sent, or stored upon different types of computer-accessible media. Generally, a computer-accessible medium can include any non-transitory storage media or memory media such as magnetic or optical media, e.g., disk or DVD/CD coupled to the computing device 1000 via the I/O interface 1030. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computing device 1000 as the system memory 1020 or another type of memory. Further, a computer-accessible medium can include transmission media or signals such as electrical, electromagnetic, or digital signals, conveyed via a communication medium such as a network and/or a wireless link, such as can be implemented via the network interface 1040.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle(R), Microsoft(R), Sybase(R), IBM(R), etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 918A-918N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Accordingly, phrases such as “a set of devices configured to” or “a collection of devices configured to” are intended to include one or more recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C, where the second processor could be part of same computing device as the first processor or part of a separate computing device as the first processor.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
receiving, at an access management (AM) service of a cloud provider network, an ordering configuration specifying a request ordering constraint to be applied when authorizing requests to services originated in association with a role, the request ordering constraint identifying at least two Application Programming Interface (API) calls of one or more services of the cloud provider network that, for the role, can be called according to a sequence defined by the ordering configuration;
receiving, at the AM service, a request originated by a compute instance of a first service to assume the role;
generating, by the AM service in response to the request, a first credential for use by the compute instance;
transmitting, by the AM service, the first credential to the compute instance;
receiving, at the AM service, a first request from a second service of the cloud provider network seeking to authorize a second request made from the compute instance to the second service, wherein the first request includes the first credential, wherein the first credential was provided by the compute instance to the second service;
determining, based on the ordering configuration and the first credential, that the second request violates the request ordering constraint; and
transmitting a message indicating that the second request is not authorized.

2. The computer-implemented method of claim 1, wherein the second request corresponds to a first API call for the second service, wherein the request ordering constraint does include the first API call for the second service within the sequence, and wherein the determining that the second request violates the request ordering constraint comprises determining that the second request was not issued at a correct point of the sequence.

3. The computer-implemented method of claim 1, wherein the determining that the second request violates the request ordering constraint comprises determining that the second request was made outside of a time window allowed by a timing constraint of the ordering configuration.

4. A computer-implemented method comprising:
receiving, at an access management (AM) service of a cloud provider network, an ordering configuration specifying a request ordering constraint;
receiving, at the AM service, a first request from a first service of the cloud provider network seeking to authorize a second request made from a client to the first service;
determining, based on the ordering configuration, that the second request violates the request ordering constraint; and
transmitting a message indicating that the second request is not authorized.

5. The computer-implemented method of claim 4, further comprising:
receiving, at the AM service, a first credential from the first service, wherein the first credential was provided by the client with the second request,
wherein the determining that the second request violates the request ordering constraint is further based on the first credential.

6. The computer-implemented method of claim 5, wherein the ordering configuration further includes a role identifier of a role, and wherein the method further comprises:
receiving, at the AM service, a request originated by the client to assume the role;
generating the first credential; and
transmitting the first credential to the client,
wherein the ordering configuration is selected for use in the determining based on the first credential.

7. The computer-implemented method of claim 4, wherein the ordering configuration is a first version, and wherein the method further comprises:
determining, using the first version of the ordering configuration during a period of time corresponding to a migration of service code, whether a first set of requests associated with an initial version of the service code violate the request ordering constraint; and
determining, using a second version of the ordering configuration, during the same period of time, whether a second set of requests associated with a migrated version of the service code violate a second request ordering constraint specified by the second version of the ordering configuration.

8. The computer-implemented method of claim 4, wherein the request ordering constraint identifies a plurality of request types in an order, wherein each of the plurality of request types identifies a service of the cloud provider network and a request method supported by that service.

9. The computer-implemented method of claim 8, wherein a first request type of the plurality of request types, within the ordering configuration, is associated with a count type indicating a number or range of requests that are allowed for the first request type.

10. The computer-implemented method of claim 9, wherein the number or range of requests allows at least two requests of the first request type.

11. The computer-implemented method of claim 4, wherein the ordering configuration further specifies a maximum allowable time for requests to be made according to the request ordering constraint.

12. The computer-implemented method of claim 11, further comprising:
determining, based on the ordering configuration, that a third request does not violate the request ordering constraint but does violate the maximum allowable time; and
transmitting a second message indicating that the third request is not authorized.

13. The computer-implemented method of claim 4, wherein the second request was originated by service code of the first service executed by a compute instance, wherein the compute instance also executes untrusted code provided or selected by a user of the cloud provider network.

14. The computer-implemented method of claim 4, further comprising:
generating an alarm indicating that the second request violated the request ordering constraint.

15. A system comprising:
a first one or more computing devices to implement a first service in a multi-tenant cloud provider network, the first service to execute one or more compute instances that will execute untrusted code; and
a second one or more computing devices to implement an Access Management (AM) service in the cloud provider network, the AM service including instructions that upon execution cause the AM service to:
receive an ordering configuration specifying a request ordering constraint;
receive a first request from the first service seeking to authorize a second request made from a client to the first service;
determine, based on the ordering configuration, that the second request violates the request ordering constraint; and
transmit a message indicating that the second request is not authorized.

16. The system of claim 15, wherein the AM service further includes instructions that upon execution cause the AM service to:
receive a first credential from the first service, wherein the first credential was provided by the client with the second request,
wherein the determination that the second request violates the request ordering constraint is further based on the first credential.

17. The system of claim 15, wherein the request ordering constraint identifies a plurality of request types in an order, wherein each of the plurality of request types identifies a service of the cloud provider network and a request method supported by that service.

18. The system of claim 17, wherein a first request type of the plurality of request types, within the ordering configuration, is associated with a count type indicating a number or range of requests that are allowed for the first request type.

19. The system of claim 18, wherein the number or range of requests allows at least two requests of the first request type.

20. The system of claim 15, wherein the ordering configuration further specifies a maximum allowable time for requests to be made according to the request ordering constraint.
